(19) United States
(12) Patent Application Publication
(10) Pub. No.: US 2010/0096404 A1
(43) Pub. Date: Apr. 22, 2010

(54) Liquid distribution

(76) Inventor: Melvin Seymour Cook, HoHoKus, NJ (US)

Correspondence Address: Melvin S. Cook, 8 Saddle Ridge Road, HoHoKus, NJ, 07423, US

(21) Appl. No.: 12/288,136

(22) Filed: Oct. 17, 2008

(51) Int. Cl. B67D 5/00

(52) U.S. Cl. 222/1; 222/4; 222/386

(57) ABSTRACT

A method for expelling gas and distributing liquid from a container is disclosed. A piston on which an outlet is formed is positioned in a container holding gas and liquid. The piston and cylinder are so formed that movements of the piston can increase the pressure of the gas and the liquid. This pressure increase can be used to expel gas from the container via the piston outlet and to distribute liquid from the container via the piston outlet and/or another outlet. Expelling the gas minimizes degradation of liquid remaining in the container due to an interaction with the gas.

### TECHNICAL FIELD

The invention disclosed is a method for expelling gas and distributing liquid from a container by using a piston on which an outlet is formed. Expelling the gas minimizes degradation of liquid remaining in the container resulting from interaction with said gas.

### BACKGROUND OF THE INVENTION

In certain cases, liquid in a container would be degraded by interaction with gas also present in the container. For example, degradation of wine in a wine bottle can result from an interaction with air that entered the opened wine bottle. In such cases, it is desirable to expel the gas from the container in order to minimize negative effects of such an interaction on liquid remaining in the container.

In an example of the prior art, a tank containing an inert gas, e.g., argon, under pressure is used to blow said inert gas into a container holding liquid and non-inert gas. When this inert gas enters the container, it expels some of the non-inert gas. However, it is a disadvantage of this particular prior art that all of the non-inert gas initially present in the container may not be expelled and any remaining non-inert gas may degrade liquid remaining in the container. A further disadvantage of this prior art is that such tanks are costly and have to be replaced or refilled after some use.

In another example of prior art, a pump is used to withdraw gas from a container also holding liquid. However, while such a withdrawal reduces contamination of liquid remaining in the container due to interaction with gas remaining in the container, it does not completely remove all of the gas. Thus, it does not completely eliminate degradation of liquid in the container.

It is an object of the present invention to provide a method for expelling gas and distributing liquid from a container. This object is achieved by the use of a piston incorporating an outlet that can, by its movement, increase the pressure of the liquid and any gas in the container, thereby enabling gas to be expelled from the container via the piston outlet and liquid to be distributed from the container via the piston outlet and/or another outlet from the container.

### SUMMARY OF THE INVENTION

The object of the method disclosed is to minimize degradation of liquid in a container resulting from interaction with gas also present in the container. This is achieved by use of a piston on which an outlet is formed that is positioned in the container, said piston by its movement being able to increase the pressure of the liquid and the gas present in the container, said increase enabling the gas to be expelled from the container via the piston outlet and liquid to be distributed from the container via the piston outlet and/or another outlet from the container. Expelling the gas minimizes degradation of liquid in the container resulting from interaction with said gas.

In a preferred embodiment of the present invention, a piston on which an outlet is formed is positioned in a container holding liquid. The piston mounted in the container encloses the liquid and gas present in the container. The surface of the side of the facing the liquid is shaped so that any gas present in the container rises to the piston outlet. The container may have a cylindrical conformation with a circular cross-section and the piston may have a circular cross-section. The pressure of the liquid and that of any gas in the container is increased by movements of the piston that reduce the volume of the container in which the gas and liquid is held. This increase allows gas to be expelled from the container and liquid to be distributed from the container via the piston outlet.

In this embodiment, the piston outlet is connected via a piston outlet tube that, in turn, is connected to a piston outlet control device, the latter being, e.g., a plug, a flap valve or a stopcock.

If the piston is removed from the container, both it and the container can be cleaned and liquid placed in the container. Alternatively, liquid can be installed into the container via the piston outlet without removing the piston from the container. When the motions of the piston reduce the volume of the container in which the piston encloses the liquid and gas held in the container, those motions increase the pressure of said liquid and gas.

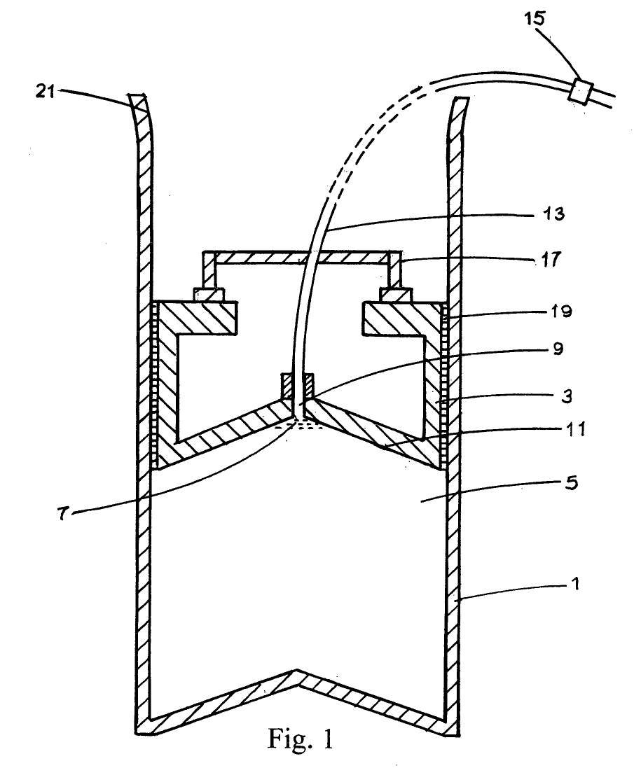

FIG. 1 depicts a preferred embodiment of the present invention. It shows a section of a cylindrical container with a circular cross-section in which a piston with a circular cross-section having an outlet is positioned. In this embodiment, the piston outlet is connected via a piston outlet tube to a piston outlet control device. The surface of the piston facing the liquid held in the container is so shaped that any gas present in the container moves to the piston outlet through which it can be expelled via the piston outlet tube when its pressure is increased by movement of the piston and the piston outlet control device is open.

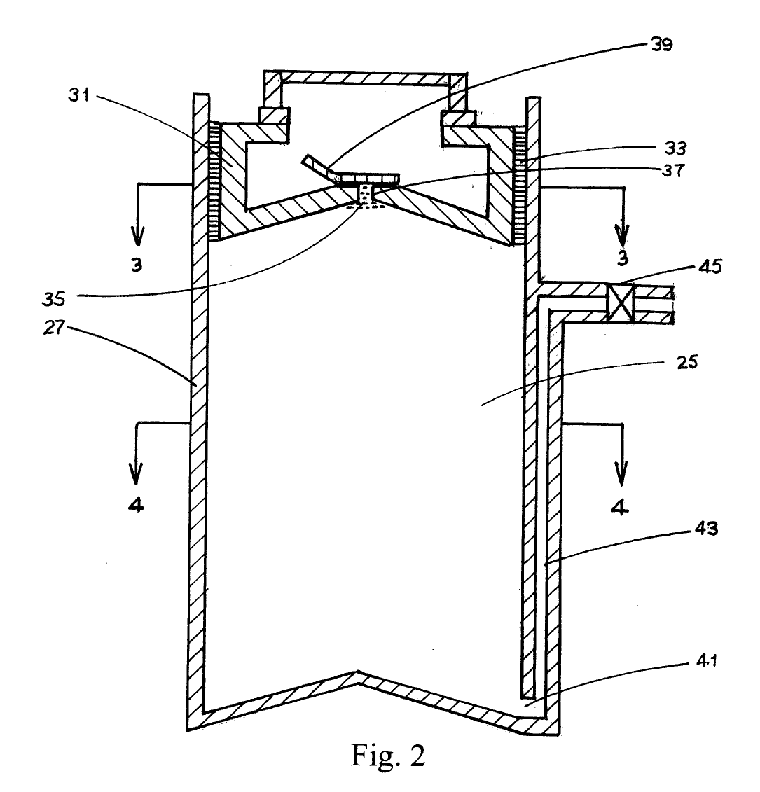

FIG. 2 depicts a section of a different embodiment of the present invention than that shown in FIG. 1. It shows a section of a cylindrical container with a circular cross-section in which a piston with a circular cross-section having an outlet is positioned. The piston outlet connected to a piston outlet control device and the piston and the container are so shaped that any gas present in the container rises to the piston outlet through which it can be expelled when the pressure of the gas has been increased by movement of the piston if the piston outlet control device is open.

This embodiment also has a liquid outlet from the container. This liquid outlet is connected to a liquid outlet tube that is itself connected to a liquid outlet control device. Distribution of liquid from the container can take place via the liquid outlet, the liquid outlet tube and the liquid outlet control device when the pressure of the liquid in the container is increased if the liquid outlet control device is open.

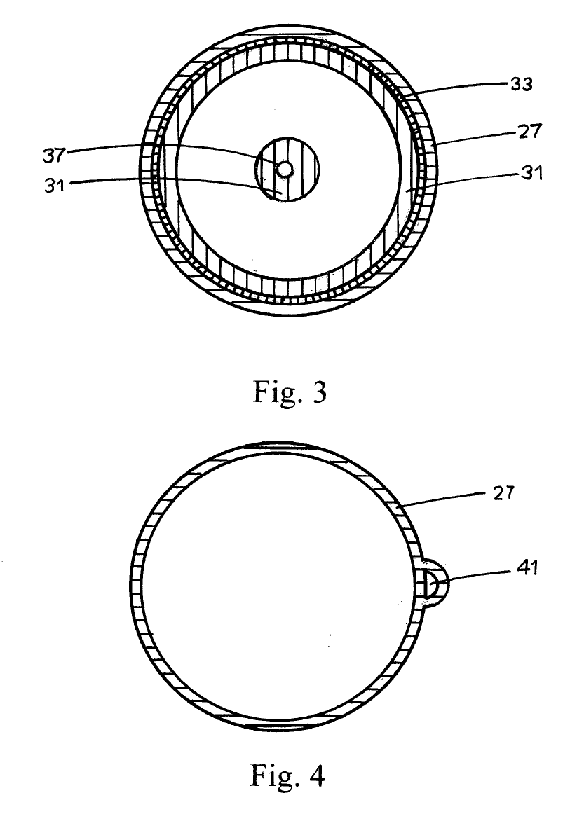

FIG. 3 depicts a different section of the embodiment shown in FIG. 2. This section shows the relationship between the container, the piston and the piston outlet.

FIG. 4 depicts another different section of the embodiment shown in FIG. 2. This section shows the relationship between the container and a liquid outlet tube that allows distribution of liquid from the container when the pressure of the liquid held in the container has been increased and the liquid outlet control device is open.

### DETAILED DESCRIPTION OF THE EMBODIMENTS

In FIG. 1, a section of a container 1 in which a movable piston 3 is mounted is shown. Liquid 5 is enclosed in the container by the piston and above the liquid, gas 7 is also enclosed in the container by the piston.

An outlet 9 is formed on the piston. The surface 11 of the piston facing the liquid is so shaped that any gas enclosed by the piston rises to the piston outlet. The piston outlet is connected via a piston outlet tube 13 to a piston outlet closure device 15. The piston outlet closure device can be, e.g., a plug, a clamp or a valve, and can be opened or shut. A handle 17 mounted on the piston can be used to move the piston. Preferably, the position of this handle can be adjusted to allow easier access to the piston outlet for the purpose of connecting a piston outlet tube to the piston outlet.

Material 19 is located on the portion of the piston surface adjacent to the container. This material prevents gas or liquid from leaving the container by moving around the piston but allows the piston to move with respect to the container. If the volume enclosed in the container by the piston is reduced, then the pressure of any enclosed liquid and gas increases.

If the piston outlet closure device is open, gas can be expelled from the container and liquid can be distributed from the container via the piston outlet when their pressure increases. If the piston outlet closure device is closed, gas cannot be expelled and liquid cannot be distributed from the container.

If the piston is removed from the container, that allows the piston and the container to be cleaned. If the diameter of the entrance region 21 of the container through which the piston is installed is larger than the diameter of the piston, that difference in diameter facilitates mounting the piston in the container, and the piston can then be moved to regions of the container where it effectively seals the volume of the container that it encloses.

In FIG. 2, a section of a different embodiment of the present invention is shown. In the embodiment shown in FIG. 2, liquid 25 is enclosed in a container 27 by a movable piston 31. Sealing material 33 placed on the piston adjacent to the container seals the container and prevents liquid or gas from moving around the piston. Movements of the piston that reduce the volume of the container it closes can increase the pressure of liquid held in the container and that of any gas 35 present in the container. The piston outlet 37 has a piston outlet control device 39, e.g., a flap valve or a plug, mounted on it. If the piston outlet control device is open and the pressure of gas enclosed by the piston has been increased, that gas can move out of the container via the piston outlet. If the piston outlet control device is closed, gas cannot move out of the container via the piston outlet. If the pressure of gas present in the container is increased by movements of the piston, said gas can be expelled from the container via the piston outlet if it is open.

In the embodiment of the present invention shown in FIG. 2, if the pressure of the liquid in the container has been increased by movement of the piston, liquid can be distributed from the container via a liquid outlet 41 that is connected to a liquid outlet tube 43 that, in turn, is connected to a liquid outlet control device 45, e.g., a plug, flap valve or a stopcock, that is open. If the liquid outlet control device is closed, liquid cannot be distributed from the container via the liquid outlet.

In FIG. 3, a section orthogonal to the section of the embodiment depicted in FIG. 2 is shown. This section shows the relationship of the container, the piston, the piston outlet and the liquid outlet.

In FIG. 4, a section of the container orthogonal to the section of the embodiment depicted in FIG. 2 that is different from the section depicted in FIG. 3 is shown. In FIG. 4, the piston and the liquid outlet tube is shown.

While particular embodiments of the invention disclosed have been described, it is obvious that the principles of the invention are applicable to other embodiments that incorporate a movable piston on which an outlet is formed that is so positioned in a container holding liquid and gas that its movements increase the pressure of said liquid and gas, an increase that allows gas to be expelled and liquid to be distributed from the container. All applications and modifications of this invention that fall within the scope and spirit of the invention are intended to be covered by the following claims.

I claim:

1. A method of distributing liquid and expelling gas from a container including the steps of positioning a piston with an outlet in said container and moving said piston so as to increase the pressure of liquid and gas enclosed in said container in order to distribute liquid and expel gas from said container via said outlet.

2. A method of distributing liquid and expelling gas from a container including the steps of positioning a piston with an outlet in said container, said container having a liquid outlet, and moving said piston so as to increase the pressure of liquid and gas enclosed in said container in order expel gas from the container via said piston outlet and to distribute liquid from the container via said liquid outlet.

3. A method of distributing liquid and expelling gas from a container in accordance with claim 1 where the surface of said piston facing into the region of said container where liquid and gas are enclosed is so shaped that gas present in said container moves to said outlet.

4. A method of distributing liquid and expelling gas from a container in accordance with claim 2 where the surface of said piston facing into the region of said container where liquid and gas are enclosed is so shaped that gas present in said container moves to said piston outlet.

5. A method of distributing liquid and expelling gas from a container in accordance with claim 3 where the outlet formed on said piston is connected via a piston outlet tube to a piston outlet control device that can be opened to allow liquid to be distributed and gas to be expelled from said container or can be closed to prevent liquid from being distributed and gas to be expelled from said container.

6. A method of distributing liquid and expelling gas from a container in accordance with claim 4 where said piston outlet is connected via a piston outlet tube to a piston outlet control device that can be opened to allow gas to be expelled from said container or can be closed to prevent gas from being expelled from said container.

7. A method of distributing liquid and expelling gas from a container in accordance with claim 6 where said liquid outlet is connected via a liquid outlet tube to a liquid outlet control device that can be opened to allow liquid to be distributed from the container or can be shut to prevent liquid from being distributed from said container.
